(19) United States
(12) Patent Application Publication
(10) Pub. No.: US 2023/0307199 A1
(43) Pub. Date: Sep. 28, 2023

(54) SWITCH DEVICE

(71) Applicant: KABUSHIKI KAISHA TOKAI RIKA DENKI SEISAKUSHO, Aichi (JP)

(72) Inventors: Yuichiro SATO, Aichi (JP); Koji KOBAYASHI, Aichi (JP)

(21) Appl. No.: 18/019,215

(22) PCT Filed: Jul. 15, 2021
(86) PCT No.: PCT/JP2021/026701

§ 371 Date: Feb. 1, 2023

(30) Foreign Application Priority Data
Aug. 7, 2020 (JP) 2020-134538

(51) Int. Cl. H01H 23/04; H01H 23/16

(52) U.S. Cl. CPC H01H 23/04; H01H 23/16; H01H 2239/006; H01H 2300/01; H01H 2231/026

(57) ABSTRACT

A switch device includes an operation body including a front knob and a rear knob arranged side by side in a front-rear direction of a vehicle, the operation body being rotatable about a shaft in a vertical direction of the vehicle. The switch device is configured to be mounted on the vehicle. The front knob is disposed at a lower position than the rear knob.

### CROSS-REFERENCES TO RELATED APPLICATIONS

The present patent application claims the priority of Japanese patent application No. 2020/134538 filed on Aug. 7, 2020, and the entire contents of Japanese patent application No. 2020/134538 are hereby incorporated by reference.

### TECHNICAL FIELD

The present invention relates to a switch device.

### BACKGROUND ART

There is a switch device for a power window device that raises and lowers window glasses of a vehicle such as an automobile (e.g., Patent Literature 1).

The switch device has an operation body to raise and lower the window glasses, and a case which houses and supports the operation body so as to be movable in a vehicle vertical direction. The operation body includes a front knob to raise and lower the window glass of the driver side door and the window glass of the front passenger side door, and a rear knob to raise and lower the window glass of the rear right-side door and the window glass of the rear left-side door. The front knob and the rear knob are associated with the window glass of the driver side door and the respective window glasses of the rear right-side door, the front passenger side door and the rear left-side door, and are integrally formed and continuous to recesses that are configured to allow a finger to be inserted.

The switch device is configured such that the recess serving as an operation space of the knob is also used as a partition wall of the knobs. Thus, in this switch device, the total length of the arrangement region of the front knob and the rear knob which are arranged in a row can be set shorter than a switch device provided with the partition wall as well as the recesses.

### CITATION LIST

### Patent Literature

Patent Literature 1: JP 2017/126505 A

### SUMMARY OF INVENTION

### Technical Problem

The switch device disclosed in Patent Literature 1 is unresolved in that an operator may not easily recognize whether he/she is operating the front knob or the rear knob.

It is an object of the invention to provide a switch device that enables the operator to easily recognize whether he/she is operating a front knob or a rear knob.

### Solution to Problem

A switch device in an embodiment of the invention comprises an operation body comprising a front knob and a rear knob arranged side by side in a front-rear direction of a vehicle, the operation body being rotatable about a shaft in a vertical direction of the vehicle,
wherein the switch device is configured to be mounted on the vehicle,
wherein the front knob is disposed at a lower position than the rear knob.

### Advantageous Effects of Invention

According to an embodiment of the invention, a switch device can be provided that enables the operator to easily recognize whether he/she is operating a front knob or a rear knob.

### BRIEF DESCRIPTION OF DRAWINGS

FIG. 1 is a perspective view showing the vicinity of a driver's seat when a switch device in an embodiment is mounted on an armrest of the driver side door of a vehicle.

FIG. 2A is a top plan view showing the switch device in the embodiment.

FIG. 2B is a cross-sectional view showing the switch device taken along a line A-A in FIG. 2A.

FIG. 2C is an explanatory diagram illustrating when a pull-up operation is performed on a front-side operating knob of the switch device in the embodiment.

FIG. 2D is an explanatory diagram illustrating when a push-down operation is performed on the front-side operating knob of the switch device in the embodiment.

FIG. 3 is a perspective view showing an operation body of the switch device in the embodiment.

FIG. 4A is a cross-sectional view showing the switch device in the embodiment taken along the line A-A, for explaining entrapment prevention measures.

FIG. 4B is a cross-sectional view showing a switch device in the first comparative example taken along the line A-A, for explaining the entrapment prevention measures.

FIG. 4C is a cross-sectional view showing a switch device in the second comparative example taken along the line A-A, for explaining the entrapment prevention measures.

FIG. 5 is a top plan view showing contact points of a sphere to the switch device in the embodiment.

FIG. 6 is a block diagram illustrating a configuration of the switch device in the embodiment.

FIG. 7 is an explanatory flowchart showing an operation of the switch device in the embodiment of the invention.

### DESCRIPTION OF EMBODIMENTS

### Embodiment

A switch device 1 in the embodiment of the invention has an operation body 10 provided with a front knob 11 and a rear knob 12, detection electrodes (20FR, 20FL, 20RR, 20RL) as a detection unit to detect an operation position on the operation body 10, a housing 30 that supports the operation body 10 so as to be rotatable about a shaft in such a manner that the operation body 10 is partially exposed on an operator side, and a control unit 50 to control devices to be controlled in accordance with the operation position detected by the detection electrodes (20FR, 20FL, 20RR. 20RL).

The switch device 1 is mounted on a vehicle 100, can acts as a switch device to receive operations for the devices to be controlled, and is applicable to various devices. In the present embodiment, a window regulator will be described as the device which is mounted on the vehicle 100 and is to be controlled.

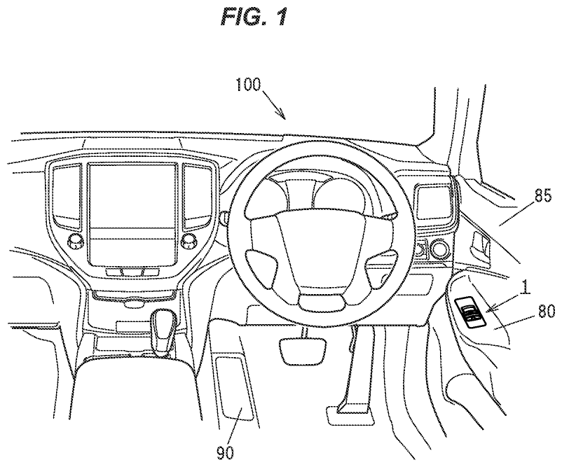

The switch device 1 is mounted on an armrest 80 of a driver side door 85 of the vehicle 100 as shown in FIG. 1 and is to open/close front-side and rear-side windows of the vehicle by controlling the window regulators. The switch device 1 includes sensing portions on the operation body 10, and the detection electrodes (20FR, 20FL, 20RR, 20RL) to detect capacitance for detecting the operation position (driver side window, front passenger side window, rear right-side window, rear left-side window) are provided on the sensing portions. Since the operation body 10 provided with the detection electrodes (20FR, 20FL, 20RR, 20RL) is formed in a recognizable shape that allows for recognition of the operation position, it is not necessary to provide a wall portion, etc., and it is possible to further reduce the size of the switch device.

### (The Operation Body 10)

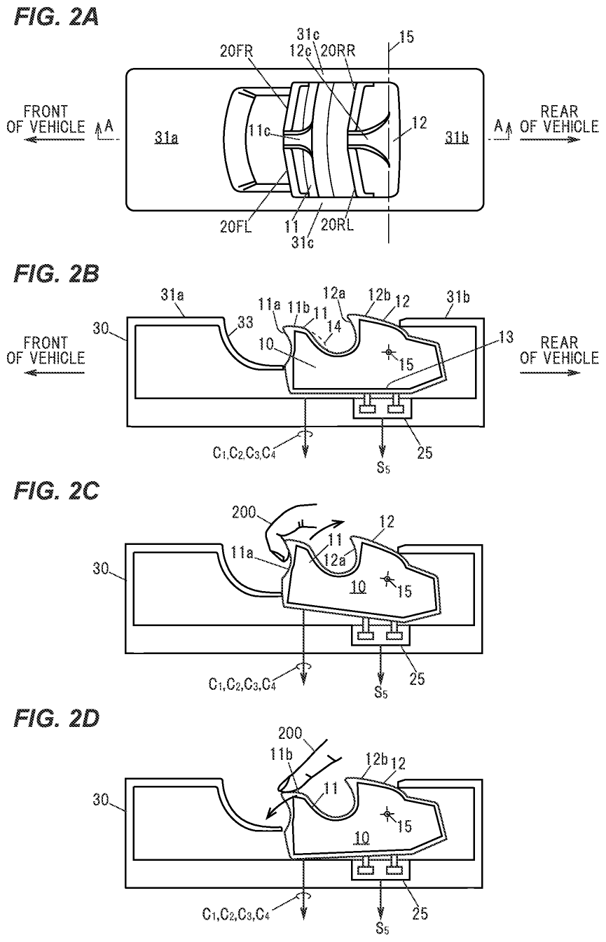

As shown in FIGS. 2A and 2B, the operation body 10 is housed in the housing 30 and is rotatably supported by a rotating shaft 15. The operation body 10 is configured such that the front knob 11 to operate a first operation position (the driver side window and the front passenger side window) and the rear knob 12 to operate a second operation position (the rear-side windows) are integrally formed.

The operation body 10 housed in the housing 30 is attached so that the front knob 11 and the rear knob 12 are arranged side by side in a front-rear direction of the vehicle 100 and the front knob 11 is located on a vehicle front side relative to the rear knob 12.

As shown in FIG. 2B, each of the front knob 11 and the rear knob 12 is composed of a side surface on the vehicle front side and an upper surface on the vehicle upper side. The side surface on the vehicle front side is an operating surface to facilitate a pull-up operation of the operation body 10 by a finger 200 as shown in FIG. 2C, and the upper surface on the vehicle upper side is an operating surface to facilitate a push-down operation of the operation body 10 by the finger 200 as shown in FIG. 2D.

Side surface operating portions 11a are provided on the side surface of the front knob 11, and upper surface operating portions 11b are provided on the upper surface of the front knob 11. Likewise, side surface operating portions 12a are provided on the side surface of the rear knob 12, and upper surface operating portions 12b are provided on the upper surface of the rear knob 12.

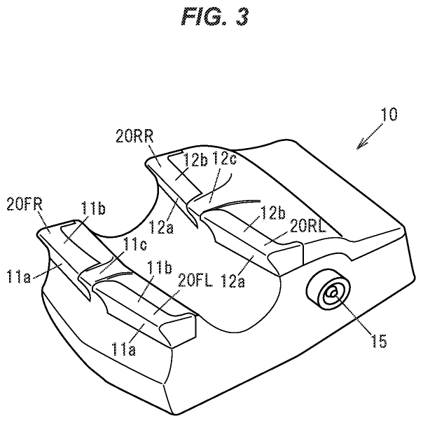

To be precise, the side surface operating portions 11a, the upper surface operating portion 11b, the side surface operating portions 12a and the upper surface operating portions 12b are provided on both the left and right sides of a left-right symmetry axis of the operation body 10 as shown in FIG. 3, i.e., located at the back and front sides of the page of FIG. 2B, not on the A-A cross section in FIG. 2B.

In addition, the front knob 11 and the rear knob 12 of the operation body 10 are arranged such that the front knob 11 is provided at a lower position than the rear knob 12. That is, the upper surface operating portion 11b of the front knob 11 is located lower than the upper surface operating portion 12b of the rear knob 12. A boundary region between the side surface operating portion 11a and the upper surface operating portion 11b of the front knob 11 is also located lower than a boundary region between the side surface operating portion 12a and the upper surface operating portion 12b of the rear knob 12. This allows an operator (a driver) to easily recognize whether he/she is operating the front side or the rear side of the operation body 10.

In the present embodiment, any position in the boundary region between the side surface operating portion 11a and the upper surface operating portion 11b of the front knob 11 is located lower than the boundary region between the side surface operating portion 12a and the upper surface operating portion 12b. However, it does not necessarily need to be configured as such. It may be configured to allow the operator to recognize heights of the front knob 11 and the rear knob 12 based on a portion of the boundary region between the side surface operating portion 11a and the upper surface operating portion 11b of the front knob 11.

In addition, on the operation body 10, a recessed portion 14 is formed between the front knob 11 and the rear knob 12. It makes it easier to ensure an operation space of the rear knob 12 relative to a shape extended from the surface of the upper surface operating portion 11b of the front knob 11 toward the rear of the vehicle, and it is thus easy to operate the rear knob 12. In addition, a space between the front knob 11 and the rear knob 12 can be reduced, allowing the size of the switch device 1 to be reduced in the front-rear direction.

As shown in FIG. 2A, the front knob 11 and the rear knob 12 of the operation body 10 are shaped such that a central portion in the left-right direction of the vehicle protrudes toward the vehicle front side. In addition, the front knob 11 and the rear knob 12 have left-right symmetrical shapes.

The above is an example of the form that allows for recognition of the operation position, and the shape of the central portion protruding toward the vehicle front side may be an arc shape, etc., other than that shown in FIG. 2A, and the central portion may have a recessed shape or a cut-out shape, etc., other than the shape protruding toward the vehicle front side. Any shape which allows for recognition of the operation position can be applied to the operating knob in the present embodiment.

The upper surface of the front knob 11 and the upper surface of the rear knob 12 respectively have a convex portion 11c and a convex portion 12c which are convex toward the vehicle upper side at the center in the left-right direction of the vehicle. The convex portion 11c is located higher than the upper surface operating portions 11b on the left and right sides thereof. The convex portion 12c is located higher than the upper surface operating portions 12b on the left and right sides thereof. In addition, the convex portion 11c and the convex portion 12c are formed in an area which is wider in the left-right direction on the vehicle rear side than the front side.

The operator, when touching the operation body 10 with the finger 200, can easily recognize the right side or the left side by the shape of the central portion protruding toward the vehicle front side or tactile feeling of the convex portion 11c or the convex portion 12c which are convex toward the vehicle upper side.

A lower portion 13 of the operation body 10 is a detection portion where a knob operation amount detection sensor 25 detects an operation amount of the operation body 10. By the pull-up operation or push-down operation as described above, the lower portion 13 of operation body 10 moves relative to the knob operation amount detection sensor 25. It is thus possible to detect the operation amount and operation direction of the operation body 10.

### (The Detection Electrodes 20FR, 20FL, 20RR, 20RL)

The switch device 1 includes the sensing portions to detect contact or proximity of a human body. In the present embodiment, the sensing portions are detection electrodes as the detection unit to detect the operation position on the operation body 10 and are the detection electrodes (20FR, 20FL, 20RR, 20RL) that detect capacitance. The detection electrodes (20FR, 20FL, 20RR, 20RL) detect capacitance values C1, C2, C3, C4, which change due to contact or proximity of a finger, etc., of the operator, and output them to the control unit 50.

On the right side of the front knob 11 and the rear knob 12, the detection electrodes 20FR, 20RR are respectively attached, as shown in FIGS. 2A and 3. Meanwhile, on the left side of the front knob 11 and the rear knob 12, the detection electrodes 20FL, 20RL are respectively attached. Each of the detection electrodes (20FR, 20FL, 20RR, 20RL) is attached to the side surface operating portion 11a and the upper surface operating portion 11b of the front knob 11 or the side surface operating portion 12a and the upper surface operating portion 12b of the rear knob 12 in such a manner that at least a part of the finger 200 comes into contact therewith or comes close thereto when a pull-up operation or a push-down operation is performed on the operation body 10.

### (The Knob Operation Amount Detection Sensor 25)

As shown in FIG. 2B, the knob operation amount detection sensor 25 is provided at a lower portion of the housing 30 to detect the operation amount of the operation body 10. The knob operation amount detection sensor 25 only needs to be a sensor that detects the pull-up operation amount and the push-down operation amount of the operation body 10 (the front knob 11, the rear knob 12).

The knob operation amount detection sensor 25 may be a switch device that outputs ON and OFF signals by a pull-up operation and a push-down operation of the operation body 10 (the front knob 11, the rear knob 12). Alternatively, the knob operation amount detection sensor 25 may be a detection sensor that outputs an analog output or a digital output in accordance with the pull-up operation amount or the push-down operation amount of the operation body 10 (the front knob 11, the rear knob 12). The knob operation amount detection sensor 25 can be a switch device or a detection sensor that outputs a signal required by the window regulator.

### (The Housing 30)

As shown in FIG. 2B, the housing 30 has an upper surface 31 serving as a frame portion around the operation body 10 and houses and rotatably supports the operation body 10 in such a manner that the operation body 10 is partially exposed. Alternatively, in place of the upper surface 31 of the housing 30, a member other than the housing, e.g., a decorative plate, etc., may be used as the frame portion around the operation body 10.

The housing 30 houses the operation body 10 in such a manner that when the operation body 10 is in the standard position, the convex portion 11c of the front knob 11 is located lower than the upper surface 31 of the housing 30 and the convex portion 12c of the rear knob 12 is located at the same height as or slightly higher than the upper surface 31 of the housing 30. The standard position of the operation body 10 is the position of the operation body 10 when the opening/closing operation is not performed.

The housing 30 also has a recessed portion 33 which is located on the vehicle front side of the operation body 10 and makes it easy to ensure an operation space of the front knob 11. The housing 30 also includes the knob operation amount detection sensor 25.

As shown in FIG. 1, the housing 30 is mounted on the armrest 80 of the driver side door 85 of the vehicle 100. The housing 30 can alternatively be mounted on a floor console 90 shown in FIG. 1. Mounting the housing 30. i.e., the switch device 1, on the floor console 90 has an effect that, e.g., a harness for wiring can be shorter or it is possible to also operate from the front passenger seat side.

### (The Operation Body 10 and the Housing 30 as Viewed by the Operator)

In the switch device 1 of the present embodiment, the front knob 11 is provided at a lower position than the rear knob 12. In addition, height of the front knob 11 is within the range in which power window entrapment accidents of small children can be prevented. This prevention measure is to not close the power window even if a knee of a small child hits and presses the operation body 10 which is housed in the housing 30 and is partially exposed on the operator side. For this purpose, the operation body 10 exposed on the operator side is shaped such that w % ben a 40 mm-diameter iron sphere simulating a small child's knee is pressed thereagainst, a straight line connecting the center point of the sphere to a contact point with the operation body 10 passes more forward of the vehicle than the rotating shaft 15 of the operation body 10.

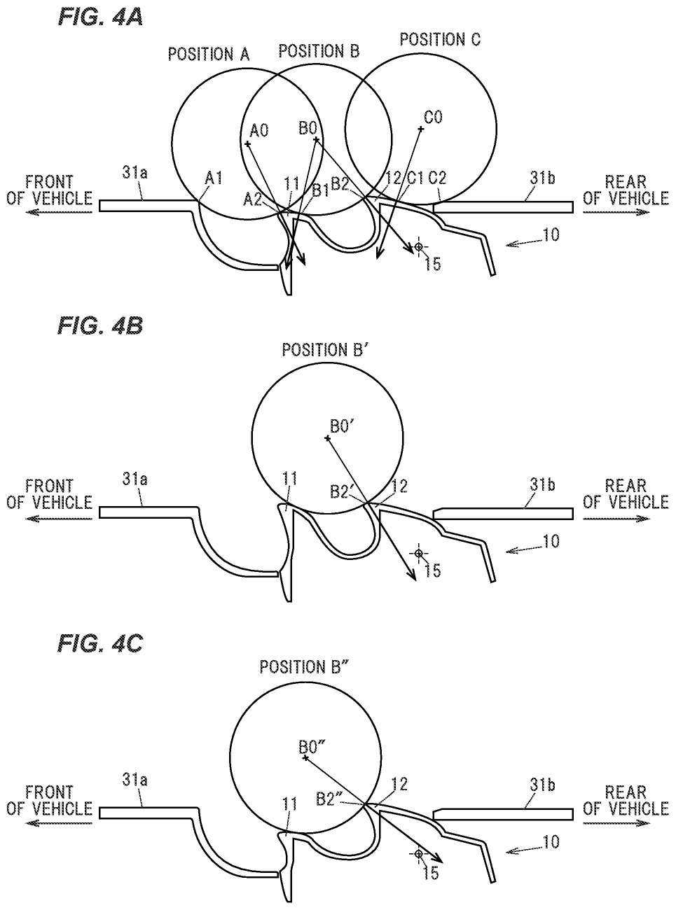

Firstly, a case is described where a 40 mm-diameter sphere is pressed against the operation body 10 on the left/right central axis of the operation body 10 exposed on the operator side. As shown in FIG. 4A, there are three positions A, B and C at which the sphere has two contact points. At those positions, straight lines connecting the center point of the sphere to the contact points with the operation body 10 all pass more forward of the vehicle than the rotating shaft 15 of the operation body 10 at the height of the rotating shaft 15 of the operation body 10.

That is, the two contact points of the sphere in the position A are a point A1 on a vehicle front-side portion 31a of a top plate of the housing 30 and a point A2 near the boundary region between the side surface and the convex portion 11c of the upper surface on the front knob 11 of the operation body 10. The two contact points in the position B are a point B1 on the convex portion 11c of the upper surface of the front knob 11 of the operation body 10 and a point B2 near the boundary region between the side surface and the convex portion 12c of the upper surface on the rear knob 12 of the operation body 10. The two contact points in the position C are a point C1 on the convex portion 12c of the upper surface of the rear knob 12 of the operation body 10 and a point C2 on a vehicle rear-side portion 31b of the top plate of the housing 30.

Then, straight lines connecting a center point A0 of the sphere in the position A to the point A1 and the point A2, straight lines connecting a center point B0 of the sphere in the position B to the point B1 and the point B2, and straight lines connecting a center point C0 of the sphere in the position C to the point C1 and the point C2 all pass more forward of the vehicle than the rotating shaft 15 of the operation body 10. In this case, when the sphere is pressed against the operation body 10, a force is applied to the operation body 10 in a direction to cause counterclockwise rotation in FIG. 4A. Hence, the operation body 10 is operated to open the window. This does not lead to an entrapment accident.

The sphere has one contact point at intermediate positions between the position A, the position B and the position C. At the intermediate position between the position A and the position B, the contact point is located on the upper surface operating portion 11b of the front knob 11. At the intermediate position between the position B and the position C, the contact point is located on the upper surface operating portion 12b of the rear knob 12. In this case, there is no concern of being trapped.

The concern of being trapped arises at the point B2 in the position B. This is because the front knob 11 of the operation body 10 is provided at a lower position than the rear knob 12 and this causes the straight line connecting the center point B0 of the sphere to the point B2 to pass more forward of the vehicle than the rotating shaft 15 of the operation body 10 at the height of the rotating shaft 15 of the operation body 10.

In the present embodiment, the front knob 11 of the actuator 10 is provided at a lower position than the rear knob 12 in the range where the straight line connecting the center point B0 of the sphere to the point B2 passes more forward of the vehicle than the rotating shaft 15 of the operation body 10 at the height of the rotating shaft 15 of the operation body 10, as shown in FIG. 4A.

If the front knob 11 of the operation body 10 is provided at the same height as the rear knob 12 as shown in the first comparative example in FIG. 4B, a straight line connecting a center point B0′ of the sphere to a point B2′ passes more forward than the rotating shaft 15 of the operation body 10 than the present embodiment in FIG. 4A.

On the other hand, if the front knob 11 of the operation body 10 is provided at a position even lower than the present embodiment in FIG. 4A as shown in the second comparative example in FIG. 4C, a straight line connecting a center point B0″ of the sphere to a point B2″ passes backward of the vehicle from the rotating shaft 15 of the operation body 10. In this case, when the sphere is pressed against the operation body 10, a force is applied to the operation body 10 in a direction to cause clockwise rotation in some cases. At this time, the operation body 10 is operated to open the window.

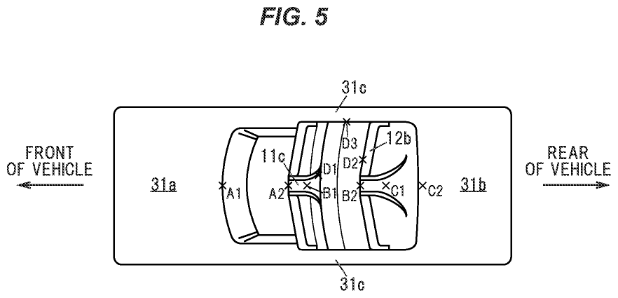

Next, a case is described where the 40 mm-diameter sphere is pressed at a position off the left/right central axis of the operation body 10 exposed on the operator side. As shown in FIG. 5, there is a position D at which the sphere has three contact points: a point D1 on the convex portion 11c of the upper surface of the front knob 11 of the operation body 10, a point D2 near the boundary region between the side surface operating portion 12a and the upper surface operating portion 12b of the rear knob 12 of the operation body 10, and a point D3 on a vehicle lateral-side portion 31c of the upper surface of the housing 30 on the right side of the operation body 10.

The point D1 is a position of the vehicle rear side of the convex portion 11c which is widened in the left-right direction. The point D2 is a position near the boundary region between the side surface operating portion 12a of the rear knob 12 and the upper surface operating portion 12b which is located lower than the convex portion 11c. The point D3 is a position of the vehicle lateral-side portion 31c of the top plate of the housing 30 which is located higher than the convex portion 11c and the upper surface operating portion 11b.

In the position D, the straight line connecting a center point DO of the sphere to the point D2 passes more forward of the vehicle than the rotating shaft 15 of the operation body 10. This is because the sphere is held by the convex portion 11c of the central portion of the operation body 10 and the vehicle lateral-side portion 31c of the top plate of the housing 30, each of which is located higher than the upper surface operating portion 11b of the front knob 11.

Other than the configuration of having one convex portion at the center, the front knob 11 may have, e.g., two convex portions at positions dividing the front knob 11 into three equal parts in the left-right direction. However, the upper surface operating portions 11b can be made wide when forming only one raise portion at the center, as in the present embodiment. It also allows for easy recognition of the left or the right when touching the side surface operating portions 11a or the upper surface operating portions 11b which are provided on the left and right of the front knob 11. Furthermore, since the convex portion 11c is shaped such that the vehicle rear side is widened in the left-right direction, the upper surface operating portions 11b can be made wide, and even when the upper surface operating portions 11b are made wide, it is possible to provide measures to prevent entrapment.

A similar position at which the sphere has three contact points also exists (not shown) at a symmetrically mirrored position of the position D. and the details are similar to the position D. At the intermediate position between the position B and the position D, there are two contact points, excluding the point D3 on the vehicle lateral-side portion 31c of the upper surface of the housing 30 on the right side of the operation body 10. Also in this case, the straight line connecting the center point DO of the sphere to the point D2 passes more forward of the vehicle than the rotating shaft 15 of the operation body 10. This is because the sphere is held by the convex portion 11c of the central portion of the operation body 10 which is located higher than the upper surface operating portion 11b of the front knob 11.

The concern of being trapped arises at the point D2 in the position D which corresponds to the point B2 in the position B. For this reason, in the present embodiment, straight lines connecting the center point of the sphere to the contact points all pass more forward of the vehicle than the rotating shaft 15 of the operation body 10, even though the explanation for the positions other than the point D2 is omitted.

### (The Control Unit 50)

The control unit 50 receives an input signal, then outputs a control signal S₁₀ according to a predetermined program, and thereby controls opening/closing of the windows of the vehicle via the window regulators. The control unit 50 includes, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. A current driver, etc., to drive the window regulator can also be provided.

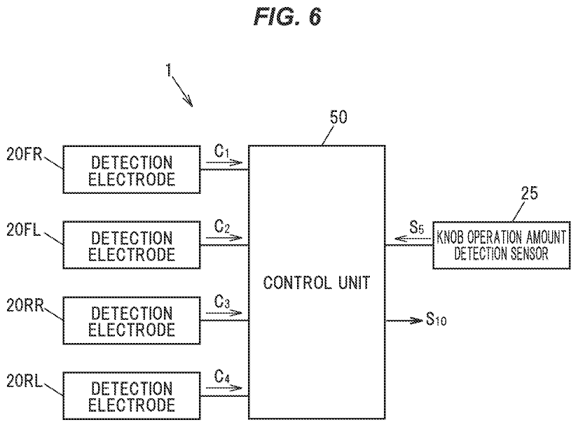

As shown in FIG. 6, the control unit 50 is connected to the detection electrodes (20FR, 20FL, 20RR, 20RL), and the respective electrode capacitance values C₁, C₂, C₃, C₄ detected by the detection electrodes (20FR, 20FL, 20RR, 20RL) are input. The knob operation amount detection sensor 25 is also connected, and detection information S₅ about a pull-up operation or a push-down operation of the operation body 10 is input. In addition, the control signal S₁₀ is calculated and output according to a predetermined program.

### (Operation of the Switch Device 1)

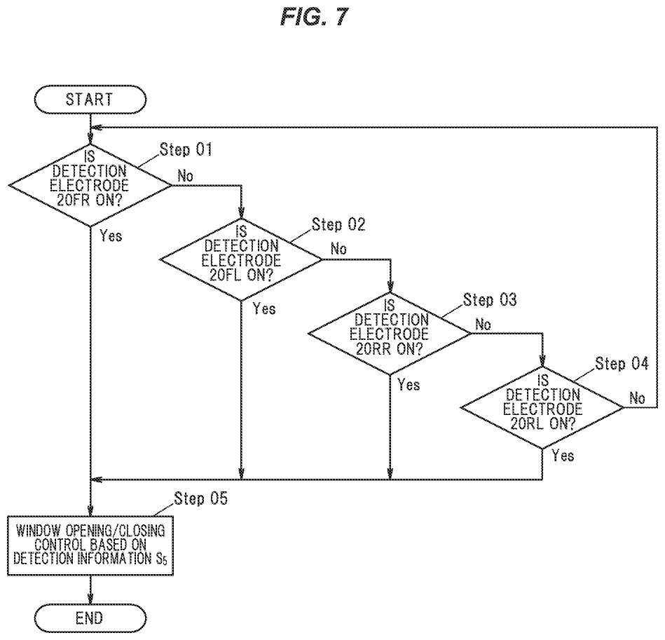

The operation of the switch device 1 will be described with the flowchart of the switch device in the first embodiment shown in FIG. 7.

### (Step 01)

Based on the capacitance value C₁ input from the detection electrode 20FR, the control unit 50 determines whether the detection electrode 20FR is ON. The control unit 50 has, e.g., a predetermined threshold Cth for determining contact or proximity of a finger, etc., to the detection electrode. The control unit 50 can determine that the detection electrode 20FR is ON, i.e., an operation has been performed on the operation position to which the detection electrode 20FR is attached (the driver side window), by comparing the capacitance value C₁ with the Cth. The process proceeds to Step 05 when the detection electrode 20FR is ON (Step 01: Yes), and the process proceeds to Step 02 when the detection electrode 20FR is not ON (Step 01: No).

### (Step 02)

Based on the capacitance value C₂ input from the detection electrode 20FL, the control unit 50 determines whether the detection electrode 20FL is ON. The control unit 50 can determine that the detection electrode 20FL is ON, i.e., an operation has been performed on the operation position to which the detection electrode 20FL is attached (the front passenger side window), by comparing the capacitance value C₂ with the Cth. The process proceeds to Step 05 when the detection electrode 20FL is ON (Step 02: Yes), and the process proceeds to Step 03 when the detection electrode 20FL is not ON (Step 02: No).

### (Step 03)

Based on the capacitance value C₃ input from the detection electrode 20RR, the control unit 50 determines whether the detection electrode 20RR is ON. The control unit 50 can determine that the detection electrode 20RR is ON, i.e., an operation has been performed on the operation position to which the detection electrode 20RR is attached (the rear right-side window), by comparing the capacitance value C₃ with the Cth. The process proceeds to Step 05 when the detection electrode 20RR is ON (Step 03: Yes), and the process proceeds to Step 04 when the detection electrode 20RR is not ON (Step 03: No).

### (Step 04)

Based on the capacitance value C₄ input from the detection electrode 20RL, the control unit 50 determines whether the detection electrode 20RL is ON. The control unit 50 can determine that the detection electrode 20RL is ON, i.e., an operation has been performed on the operation position to which the detection electrode 20RL is attached (the rear left-side window), by comparing the capacitance value C₄ with the Cth. The process proceeds to Step 05 when the detection electrode 20RL is ON (Step 04: Yes), and the process returns to Step 01 when the detection electrode 20RL is not ON (Step 04: No).

### (Step 05)

The control unit 50 controls opening/closing of the window of the vehicle via the window regulator by outputting the control signal S₁₀ based on the detection information S₅ about the pull-up operation or push-down operation of the operating knob 10. That is, the operation position is identified by the detection electrode, and an opening operation or a closing operation of the window corresponding to the operation position (driver side, front passenger side, rear right-side, rear left-side) is controlled based on the detection information S₅.

The operation of the switch device 1 ends after the above-described series of steps. However, the operation described above can be repeatedly executed as necessary.

### Effects of the Embodiment

(1) In the switch device 1 in the present embodiment, the front knob 11 is arranged at a lower position than the rear knob 12. This allows the operator to easily recognize whether he/she is operating the front side or the rear side of the operation body 10.
(2) The operation body 10 exposed on the operator side is shaped such that when a 40 mm-diameter steel sphere is pressed thereagainst, straight lines connecting the center point of the sphere to contact points with the operation body 10 pass more forward of the vehicle than the rotating shaft 15 of the operation body 10. This provides measures to prevent power window entrapment accidents since the power window is not closed even when pressed by a small child's knee.
(3) In the switch device 1 of the present embodiment, the convex portion 11c located higher than the upper surface operating portions 11b is formed on the upper surface of the front knob 11. In addition, the upper surface of the housing 30 (the frame around the operation body 10) located higher than the upper surface operating portions 11b is present on both sides on the outer side of the upper surface operating portions 11b. Furthermore, the convex portion 11c is formed in an area which is wider in the left-right direction on the vehicle rear side than the front side. Each of these allows the straight lines connecting the center point of the sphere to the contact points with the operation body 10, which are mentioned in (2), to easily pass more forward of the vehicle than the rotating shaft 15 of the operation body 10. Then, since the height difference between the front knob 11 and the rear knob 12 is increased while preventing power window entrapment accidents, the operator can easily recognize whether he/she is operating the front side or the rear side of the operation body 10.

The, by increasing the.
(4) The operation body 10 is formed in a recognizable shape that allows for recognition of the operation position (the driver side window, the front passenger side window, the rear right-side window, the rear left-side window). As shown in FIG. 2A, the central portion 11c of the front knob 11 and the central portion 12c of the rear knob 12 are formed in a protruding shape. The operator (driver), when touching the front knob 11 or the rear knob 12 with the finger 200, recognizes the central portion 11c or 12c having a protruding shape and can thereby easily recognize the right side or the left side.

Although some embodiment and modifications of the invention have been described, these embodiment and modifications are merely examples and the invention according to claims is not to be limited thereto. These new embodiment and modifications may be implemented in various other forms, and various omissions, substitutions and changes, etc., can be made without departing from the gist of the invention. In addition, not all combinations of the features described in these embodiment and modifications are necessary to solve the problem of the invention. Further, these embodiment and modifications are included within the scope and gist of the invention and also within the invention described in the claims and the range of equivalency.

### REFERENCE SIGNS LIST

1 SWITCH DEVICE
10 OPERATION BODY
11 FRONT KNOB
11a SIDE SURFACE OPERATING PORTION
11b UPPER SURFACE OPERATING PORTION
11c CONVEX PORTION
12 REAR KNOB
12a SIDE SURFACE OPERATING PORTION
12b UPPER SURFACE OPERATING PORTION
12c CONVEX PORTION
20FL, 20FR, 20RL, 20RR DETECTION ELECTRODE
25 KNOB OPERATION AMOUNT DETECTION SENSOR
30 HOUSING
50 CONTROL UNIT
100 VEHICLE

1. A switch device, comprising an operation body comprising a front knob and a rear knob arranged side by side in a front-rear direction of a vehicle, the operation body being rotatable about a shaft in a vertical direction of the vehicle,
wherein the switch device is configured to be mounted on the vehicle,
wherein the front knob is disposed at a lower position than the rear knob.

2. The switch device according to claim 1, wherein the switch device is used to open and close a power window, wherein the switch device comprises a frame portion around the operation body, wherein the front knob comprises a convex portion that is located higher than an upper surface operating portion of the front knob, and wherein a portion of the operation body exposed from the frame portion on an operator side is shaped such that when a 40 mm-diameter sphere is pressed against the operation body, a straight line connecting a center point of the sphere to a contact point with the operation body passes more forward of the vehicle than a rotating shaft of the operation body.

3. The switch device according to claim 2, wherein the frame portion around the operation body is disposed at a position higher than the upper surface operating portion of the front knob, and wherein the convex portion of the front knob is disposed on a central portion of the front knob in a left-right direction of the vehicle.

4. The switch device according to claim 2, wherein the convex portion of the front knob is formed in an area that is wider in the left-right direction on the rear side of the vehicle than the front side.

5. The switch device according to claim 1, wherein the rear knob comprises a convex portion that is located higher than an upper surface operating portion of the rear knob.

6. The switch device according to claim 5, wherein the convex portion of the rear knob is formed in an area that is wider in the left-right direction on the rear side of the vehicle than the front side.

7. The switch device according to claim 1, wherein the front knob and the rear knob have a shape such that a central portion in the left-right direction of the vehicle protrudes toward the front side of the vehicle.

8. The switch device according to claim 2, wherein the frame portion houses and rotatably supports the operation body in such a manner that the operation body is partially exposed.

9. The switch device according to claim 1, wherein the front knob and the rear knob comprise side surface operating portions on side surfaces on the front side of the vehicle.

10. The switch device according to claim 2, further comprising:
a first detection unit to detect an operation position on the operation body;
a second detection unit to detect an operation amount and an operation direction of the operation body; and
a control unit to control the power window based on a detection result from the first detection unit and the second detection unit.
